(19) United States
(12) Patent Application Publication
(10) Pub. No.: US 2020/0300275 A1
(43) Pub. Date: Sep. 24, 2020

(54) VALVE DEVICE

(71) Applicant: HYDAC SYSTEMS & SERVICES GMBH, Sulzbach/Saar (DE)

(72) Inventors: Sascha Alexander BIWERSI, Mettlach (DE); Stephan SCHMITT, St. Ingbert (DE)

(21) Appl. No.: 15/779,150

(22) PCT Filed: Nov. 23, 2016
(86) PCT No.: PCT/EP2016/001974

§ 371 Date: May 25, 2018

(30) Foreign Application Priority Data
Dec. 3, 2015 (DE) 10 2015 015 685.3

(51) Int. Cl. F15B 13/044; H02K 7/116

(52) U.S. Cl. CPC F15B 13/0444; F16K 31/52483; H02K 7/116

(57) ABSTRACT

Valve device consisting of at least one valve piston (1) which is arranged in a valve housing (3) in such a way as to be longitudinally movable along a movement axis (5) by an electric motor (23) and which at least partially connects or disconnects fluid connection points (P, A, B) in the valve housing (3) to or from each other, said valve device being characterized in that the drive axis (25) of the electric motor (23) intersects the movement axis (5) of the valve piston (1), runs through the top face (6) and/or the bottom face (8) of the valve housing (3), and is arranged in the valve housing (3) in such a way as to extend (10) parallel or at an angle to the fluid connection points (P, A, B).

The invention relates to a valve device consisting of at least one valve piston which is arranged in a valve housing in such a way as to be longitudinally movable along a movement axis by an electric motor and which at least partially connects or disconnects fluid connection points in the valve housing to or from each other. The valve housing consists in a regular manner of paired opposite longitudinal sides and face sides and a top side and a bottom side.

Electric motor activation of valve devices is already known. This functional principle offers numerous advantages over hydraulic actuators. In the case of series applications, when valve devices are used in a hydraulic directional valve block with a plurality of side-by-side control valve segments for control systems of mobile work machines, in particular of agricultural machines, a particularly narrow construction is sought for the individual valve segments, so as to keep the total width of the directional valve block within limits which are acceptable and suitable for the respective installation situation.

U.S. Pat. No. 7,591,448 B2 discloses a valve device that can be activated by an electric motor of the type described above, which is envisaged for series applications, i.e. for valve blocks with control valves lying side-by-side. To achieve a sufficiently narrow construction of the individual segments for the series application, in this solution an internal rotor stepping motor is provided, the rotational axis of which extends in the direction of the longitudinal linkage of the corresponding valve block. To obtain a narrow construction with the segment width of less than 44 mm which is standard in series applications, a narrow design of the stepping motor with little width measured in the direction of the rotational axis is required, which is indicated with the letter H in the cited document. The poor efficiency and power density of stepping motors provides only very little torque, even when the motor diameter, which is identified with the letter D in the cited document, is selected sufficiently large relative to the axial width H. The known solution envisages a ratio of D/H of more than 1.6. The little available torque results in a very significant reduction, which means that the actuator works slowly with a very high restoring torque, so that it is unsuitable for a use with mobile valves. In addition, due to its detent torque the stepping motor has high self-locking, which makes it difficult to provide the valve device with a functionally reliable, spring-centered center position.

Document EP 2 916 052 A1 made known a valve disk having a main body, which is formed from paired opposite longitudinal sides and face sides and a top side and a bottom side and in which a control slide valve or valve piston is accommodated in a longitudinally displaceable manner. The known solution also has a gear drive which can be driven with an electric motor, which drives a gear rack connected to the control slide valve or valve piston, which is secured via a flexible coupling rod to the control slide valve or valve piston. Both the electric motor and the gear drive with the gear rack are flange connected at the face side to the housing of the valve disk, in order to thus obtain a narrow construction for the valve disk for the purpose of construction of such valve disks to form complete valve blocks. This known valve device is thus built large in the longitudinal direction parallel to its longitudinal sides, and in order to obtain easy movability of the control slide valve or valve piston via the gear rack, the flexible coupling rod is to be provided between same, which results in increased costs including during assembly.

Given this prior art, the invention addresses the problem of providing a valve device which is distinguished by particularly advantageous operating behavior, which has a small construction and which is inexpensive to realize.

According to the invention, this problem is solved by a valve device having the features of claim 1, 2 or 3 in its entirety.

According to the characterizing portion of claim 1, this invention is distinguished in that the drive axis of the electric motor or its notional extension intersects the movement axis of the valve piston. With this motor arrangement a narrow construction can be realized, without the principle of the stepping motor having to be used, instead electronically controlled electric motors can be advantageously used. The disadvantages associated with stepping motors of low dynamic torque and of significant required reduction with correspondingly significant self-locking are thus eliminated. In particular, in such an arrangement the motor housing preferably does not project to the side over the valve housing, so that a narrow segment construction is obtained, which plays a role when a number of such valves are to be mounted in a side-by-side arrangement on third components, such as components of work machines and commercial vehicles.

According to the characterizing portion of claims 2 and 3 the invention is furthermore distinguished in that the drive axis of the electric motor passes through the top side or bottom side of the valve housing or its respective notional extension or in that the drive axis of the electric motor or its notional extension is arranged extending parallel or obliquely relative to the fluid connection points in the valve housing, to the extent that they emerge from the valve housing on the top side and/or bottom side thereof. This makes it possible, by contrast with the prior art according to EP 2 916 052 A1, to place the drive unit for the valve piston from the front face side region, on which the known drive unit projects considerably, preferably on the top side of the valve device, which not only saves space, but also permits a direct drive for the valve piston without interposing flexible coupling rods or the like. There is no equivalent of this in the prior art, in particular there is no self-locking in the drive train for the valve piston. If the drive device, in particular in the form of the electric motor, is mounted on the top side of the valve housing or parts of this valve housing, in a space saving manner and in a manner which supports the segment construction, parts of an emergency manual activation can emerge on the bottom side of the valve housing or parts thereof.

The longitudinal sides of the respective valve housing form in their notional extension parallel extending boundary planes, between which the possible planes lie with the movement axis, which are intersected by the motor drive axis or its notional extension. The motor drive axis preferably intersects the movement axis of the valve piston vertically. However, a so-called oblique engagement is also possible if, instead of a pinion gear gear rack engagement a screw arrangement or another suitable gear arrangement is used, even if such gears are to be self-locking.

Unlike the cited known solution according to the US patent, with the electric motor having a rotor and a stator the ratio D to H of an average diameter D of a notional circle through the center points of the stator coils, divided by a total height H of the coils in a direction parallel to the drive axis of the rotor, can be smaller than 1.5, preferably smaller than 1. By contrast to the prior art, the valve device according to the invention can thus be configured more freely.

In segmental construction a determinable number of valve housings can be provided in a side-by-side arrangement with electric motors mounted thereon, with the electric motors being arranged in the direction of the side-by-side arrangement within the boundaries of the respective valve housing.

Such a side-by-side arrangement can be advantageously realized by means of respective introduced electric motors in the form of permanently excited internal rotor synchronous motors.

The arrangement can advantageously be such that the respective engine is controlled via a digital controller with absolute rotational position recognition.

In a particularly advantageous exemplary embodiment, the valve piston has at its one free end a gear rack, which engages with a drive pinion of the electric motor or of a gear connected to the electric motor.

As the gear a spur gear or a single-stage or multi-stage, in particular a two-stage planetary gear can advantageously be provided.

The arrangement can be such that in the region of the gear rack a preferably hand activatable emergency activation is connected to the valve piston.

In particularly advantageous exemplary embodiments, at least the gear rack of the valve piston and the drive pinion of the electric motor or any gears connected to this motor immersed in oil can be operated in a chamber connected to the valve housing and sealed relative to this housing, which can also be a component of the valve housing. Such a construction is distinguished by a particularly high operational reliability during long-term operation.

With regards to the formation of the assigned directional valve, the arrangement can advantageously be such that at the other end facing away from the gear rack the valve piston is returned to a neutral position in the case of an unactivated electric motor by means of a reset device, preferably using a compression spring.

The arrangement can be such that in the neutral position a pressure supply connection P is separated from two service connections A, B and that in opposite movement positions, realized by the activated electric motor, the valve piston connects in one case the one A and in one case the other B service connection to the pressure supply connection P.

The invention is explained in detail below with reference to an exemplary embodiment depicted in the drawings, in which:

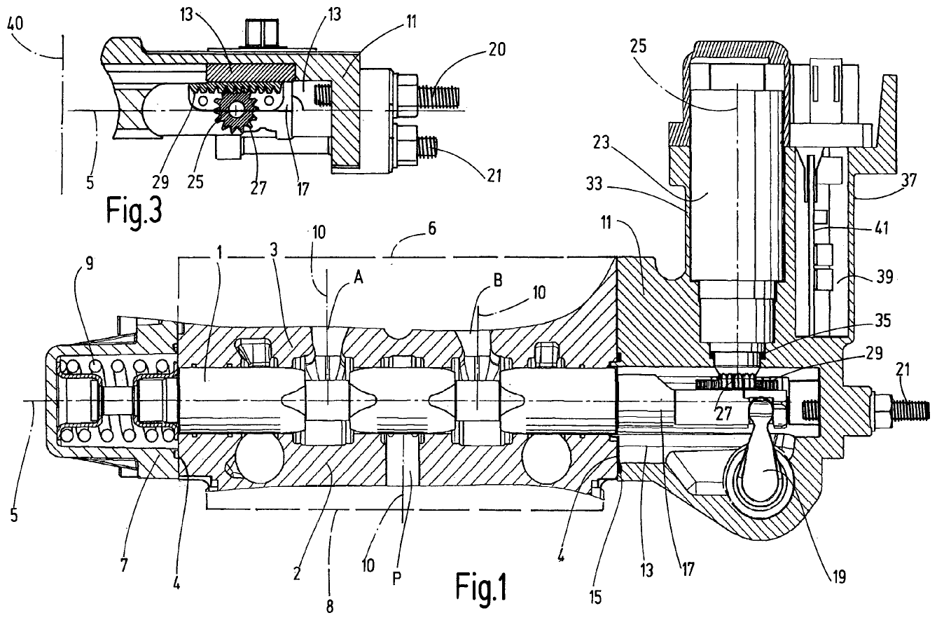

FIG. 1 shows a broken off longitudinal section, which shows the valve housing arrangement only in part, of an exemplary embodiment of the valve device according to the invention;

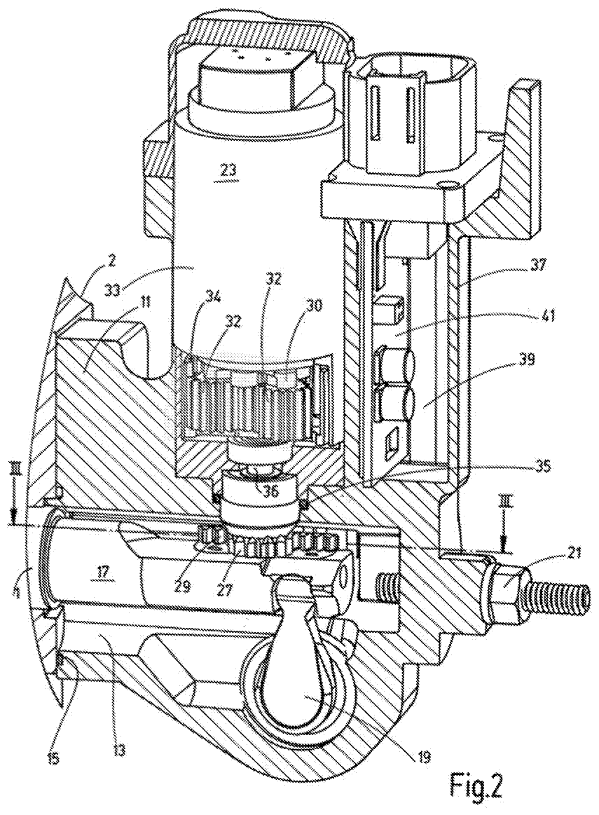

FIG. 2 shows a partial longitudinal section, depicted on a larger scale compared with FIG. 1, of only the activation part of the exemplary embodiment and

FIG. 3 shows a sectional depiction along the cutting line III-III of FIG. 2.

With reference to the drawings the valve device according to the invention is explained using the example of an LS directional valve in the form of a slide valve. The construction of the valve housing with the associated sliding piston corresponds, in the exemplary embodiment shown in the figures, to the known valve device, as disclosed in document DE 10 2013 021 317 15 A1, to which reference will be made. The difference of the invention compared with same is that an electric motor actuator is provided, the construction of which permits a particularly advantageous use of the valve device according to the invention for series applications in valve blocks with valve devices arranged closely next to one another. When the patent application uses the terms “top side” and “bottom side”, these specifications refer to a normal installation situation, as depicted in the figures.

In accordance with the solution disclosed in the cited document, a sliding piston 1 can be moved in a valve housing 3 along an axis 5. The valve housing 3 has paired opposite longitudinal sides 2 and face sides 4. The valve housing 3 additionally has a top side 6 and a bottom side 8. According to the depiction of FIG. 1 these housing walls are depicted in dashed lines showing only their respective outlines. It shall be understood that in a respective notional extension these sides extending in planes plane-parallel can project in all directions. On the valve housing 3 there are additionally, as is the norm for such valve devices, housing connections such as a pressure supply connection P and two service connections A and B. The connections P, A, B which are introduced in a regular manner in the form of bores in the valve housing 3 each have longitudinal axes 10 which are depicted with dashed lines. Additional connections, such as tank return connections or connections e.g. for a pressure maintenance valve, are not numbered in FIG. 1.

A spring arrangement 9 located in the housing end region 7 defines, in a manner which is standard for such directional valves, a neutral or central position for the sliding piston 1, as occupied by the sliding piston 1 in FIG. 1. At the end opposite the housing end region 7 which is situated on the right side in FIG. 1 a housing end part 11 is connected to the valve housing 3, which contains an inner chamber 13 extending coaxial to the axis 5, which is sealed relative to the valve housing 3 by means of a seal 15, but which is to be considered to be a component of the valve housing 3. In accordance with the valve device known from the cited document DE 10 2013 021 317 A1, the sliding piston 1 extends with an end section 17 into the chamber 13. In a manner also corresponding to the known solution, the slide end section 17 inside the chamber 13 cooperates with an activation part 19 of an emergency activation and a stroke length limitation of the sliding piston 1. Because this likewise corresponds to the solution known from the cited document with setscrews 20 and 21, a more detailed description of this aspect is not required.

The electric motor 23 serving as an actuator is arranged on the housing end part 11 in such a way that its drive axis 25 vertically intersects the movement axis 5 of the sliding piston 1 and a pinion 27 located at the end of the motor shaft is located inside the chamber 13. As can be seen most clearly from FIG. 3, a gear rack 29 is fastened on the end section 17 of the sliding piston 1, which engages with the pinion 27. As in the cited known solution, the sliding piston 1 is guided in a non-rotatable manner in the chamber 13, so that the gear rack 29 remains, during axial movements brought about by the pinion 27 in contact with a guiding sliding element 31 which, cf. FIG. 3, is fastened on the wall of the chamber 13. The chamber 13 which is sealed towards the outside is oil-immersed from the valve housing 3, so that the gear arrangement formed by the pinion 27, gear rack 29 and sliding element 31 functions in an oil-immersed manner. The seal relative to the motor housing 33 of the electric motor 23 is formed by a rotary seal 35 which is radial to the drive axis 25. Instead of the depicted sliding element 31 a roller bearing or a roller could also be used.

In the depicted exemplary embodiment, an electric motor 23 in the form of a permanently excited internal rotor synchronous motor is provided. With a dimensional ratio of D to H of significantly less than 1.5 and preferably of less than 1, a permanently excited synchronous motor provides a torque permitting a rapid and reliable valve activation with a slim construction, which permits a tight side-by-side arrangement of valve devices in valve blocks. The drive can be realized via a direct drive by means of the pinion 27 and gear rack 29. In addition to such a spur gear, a multi-stage and in particular a two-stage planetary gear or an eccentric spur gear could be provided. The little or absent self-locking of the drive with a permanently excited synchronous motor permits a simple construction of an emergency manual activation.

As is shown in particular in FIG. 2, a planetary gear 30 is used for driving the pinion 27. The individual planetary gears 32 engage around a central sun gear which is not depicted in detail, which planetary gears are engaged on their external circumference side or output side with a central wheel 34 inside the motor housing 33, which is in turn connected via a rod connection drive 36 to the pinion 27 to be driven. The sun gear of the planetary gear 30 which is not depicted in detail is in turn activated or driven by the electric motor 23 along its drive axis 25 (cf. FIG. 1). As FIG. 1 additionally shows, this drive axis 25 or the motor housing 33 passes through the notional extension of the top side 6 of the valve housing 3. Furthermore, this drive axis 25 of the electric motor 23 is orientated parallel to the longitudinal axes 10 of the fluid connections P, A, B. If the rack-and-pinion drive 29 were to be exchanged for a screw drive part which is not depicted or described in detail, an oblique position of the drive axis 25 of the electric motor 23 would also be possible, i.e. the motor axis 25 would intersect at an oblique angle the top side 6 of the valve housing 3 itself or its notional extension (not depicted).

For the control of the motor 23 an electronics housing 37 is cast on the motor housing 33 and forms a cavity 39 which is sealed relative to the motor housing, in which an electronics board 41 is accommodated. Both the cavity 39 of the electronic housing 37 and the motor housing 33 are encapsulated independently of one another and sealed against moisture from the outside. The board 41 can have a digital controller, which recognizes the rotational position of the motor 23, for example by means of a sensor-free position measurement (rotor location determination by means of the motor winding). The activation can take place by means of a CAN BUS or a similar input signal.

As FIG. 3 shows, the pinion 27 is centrally arranged in the chamber 13, so that the drive axis 25 of the electric motor 23 vertically intersects the movement axis 5. For the diameter of the round motor housing 23 in the direction of the side-by-side arrangement in a valve block, the entire width of the respective valve device is thus available. With a correspondingly small diameter of the electric engine 23 and of the motor housing 33 it would also be possible to realize a lateral displacement of the drive axis 25 from the movement axis 5, for example in the direction of the axis 40 shown in FIG. 3, which extends vertically on the movement axis 5, and the drive axis 25, would still vertically intersect the plane containing the movement axis 5.

1. A valve device consisting of at least one valve piston (1) which is arranged in a valve housing (3) in such a way as to be longitudinally movable along a movement axis (5) by an electric motor (23) and which at least partially connects or disconnects fluid connection points (P, A, B) in the valve housing (3) to or from each other, characterized in that the drive axis (25) of the electric motor (23) intersects the movement axis (5) of the valve piston (1).

2. The valve device consisting of at least one valve piston (1) which is arranged in a valve housing (3) in such a way as to be longitudinally movable along a movement axis (5) by an electric motor (23) and which at least partially connects or disconnects fluid connection points (P, A, B) in the valve housing (3) to or from each other, wherein the valve housing (3) is formed from paired opposite longitudinal sides (2) and face sides (4) and a top side (6) and a bottom side (8), characterized in that the drive axis (25) of the electric motor (23) passes through the top side (6) and/or bottom side (8) of the valve housing (3) or its respective notional extension.

3. The valve device consisting of at least one valve piston (1) which is arranged in a valve housing (3) in such a way as to be longitudinally movable along a movement axis (5) by an electric motor (23) and which at least partially connects or disconnects fluid connection points (P, A, B) in the valve housing (3) to or from each other, wherein the valve housing (3) is formed from paired opposite longitudinal sides (2) and face sides (4) and a top side (6) and a bottom side (8), characterized in that the drive axis (25) of the electric motor (23) is arranged extending parallel or obliquely to the longitudinal axes (10) of the fluid connection points (P, A, B) in the valve housing (3), when these emerge from the valve housing (3) on its top side (6) and/or bottom side (8).

4. The valve device according to claim 1, characterized in that the electric motor (23) has a rotor and a stator and in that the ratio of D to H of an average diameter D of a notional circle through the center point of the stator coils, divided by a total height H of the coils in a direction parallel to the drive axis (25) of the rotor, is less than 1.5, preferably less than 1.

5. The valve device according to claim 1, characterized in that in a segmental construction a determinable number of valve housings (3) is provided along its longitudinal sides in a side-by-side arrangement with electric motors (23) mounted thereon and in that the electric motors (23) are arranged in the direction of the side-by-side arrangement inside the longitudinal sides of the respective assignable valve housing (3).

6. The valve device according to claim 1, characterized in that the respective electric motor (23) used is a permanently excited internal rotor synchronous motor.

7. The valve device according to claim 1, characterized in that the valve piston (1) has at its one free end a gear rack (29), which engages with a drive pinion (27) of the electric motor (23) or a gear connected to the electric motor (23).

8. The valve device according to claim 1, characterized in that the gear is a spur gear (27, 29) or a single-stage or multi-stage, in particular a two-stage planetary gear.

9. The valve device according to claim 1, characterized in that in the region of the gear rack (29) a preferably manually activatable emergency activation (19) is connected to the valve piston (1).

10. The valve device according to claim 1, characterized in that at least the gear rack (29) of the valve piston (1) and the drive pinion (27) of the electric motor (23) or any gear connected to this motor (23) immersed in oil can be operated in a chamber (13) connected to the valve housing (3) and which is sealed relative to this housing (3).

11. The valve device according to claim 1, characterized in that on the other end (7) facing away from the gear rack (29) the valve piston (1) is returned to a neutral position in the case of an unactivated electric motor (23) by means of a reset device, preferably using a compression spring (9).

12. The valve device according to claim 1, characterized in that in the neutral position a pressure supply connection (P) is separated from two service connections (A, B) and in that in opposite movement positions, realized by the activated electric motor (23), the valve piston (1) connects in one case the one service connection (A) and in one case the other service connection (B) to the pressure supply connection (P).
